(19) United States
(12) Patent Application Publication
(10) Pub. No.: US 2015/0083096 A1
(43) Pub. Date: Mar. 26, 2015

(54) TURBOCHARGER TURBINE BOOSTER

(71) Applicants: John R. Zagone, Westmont, IL (US); Jeremy Grant Schipper, Chicago, IL (US); Rade Milanovic, Oak Park, IL (US); Jack Morais, Arlington Heights, IL (US)

(72) Inventors: John R. Zagone, Westmont, IL (US); Jeremy Grant Schipper, Chicago, IL (US); Rade Milanovic, Oak Park, IL (US); Jack Morais, Arlington Heights, IL (US)

(73) Assignee: International Engine Intellectual Property Company , LLC, Lisle, IL (US)

(21) Appl. No.: 14/394,845

(22) PCT Filed: Apr. 16, 2012
(86) PCT No.: PCT/US12/33783

§ 371 Date: Oct. 16, 2014

(51) Int. Cl. F02B 37/20; F01N 3/22

(52) U.S. Cl. CPC F02B 37/20; F01N 3/22
USPC 123/568.11

(57) ABSTRACT

A method of operating the turbine booster to improve engine operating response and to increase the effectiveness of emission control devices is disclosed. A turbocharger turbine booster for a turbo charged internal combustion engine provides pressurized air to the turbocharger turbine and increases the oxygen in engine exhaust without increasing the engine combustion oxygen content.

### BACKGROUND

Embodiments described herein concern improving performance of low emission internal combustion engines and maintaining the efficiency of engine emission control devices. In particular, the embodiments concern turbocharger transient response at low engine speed while improving the efficiency of an exhaust oxidation catalyst.

Air is introduced into many internal combustion engines by one or more turbochargers. Diesel engines may have two turbochargers, a low pressure turbocharger that provides air to the inlet of a high pressure turbocharger that provides air to the diesel engine. The turbochargers have compressors that discharge pressurized air. The turbocharger compressors are driven by turbocharger turbines that are driven by the engine exhaust. When exhaust flow to the turbocharger turbine decreases, the effectiveness of the turbocharger to provide pressurized air decreases.

One aspect of emission control of diesel engines is diverting exhaust gas into the engine air intake. Diverting exhaust into the engine air intake reduces the exhaust available to drive turbochargers and reduces the volume percent of oxygen in the engine exhaust.

### SUMMARY

Embodiments concern introducing pressurized air into the exhaust system of a low emission internal combustion engine at one or more locations at which the air will increase the energy driving a turbocharger turbine.

Embodiments may also concern introducing air into the exhaust system of a low emission internal combustion engine at one or more locations at which the oxygen content of exhaust flow into a diesel oxidation catalyst is increased.

Embodiments may also concern providing a nozzle in a turbocharger turbine housing at a location at which high pressure air introduced through the nozzle will drive the turbocharger turbine without detrimentally increasing pressure that resists flow of exhaust to the turbocharger turbine.

### BRIEF DESCRIPTION OF THE DRAWINGS

FIG. 1 is a schematic representation of air intake and exhaust systems of a diesel engine.

FIG. 2 is a schematic representation of air intake and exhaust systems of a diesel engine.

FIG. 3 is a cross section representation of a turbocharger turbine housing.

FIG. 4 is a schematic representation of another embodiment of air intake and exhaust systems of a diesel engine.

FIG. 5 is a schematic representation of another embodiment of air intake and exhaust systems of a diesel engine.

FIG. 6 is a schematic representation of another embodiment of air intake and exhaust systems of a diesel engine.

### DETAILED DESCRIPTION OF EMBODIMENTS

Embodiments described herein a low emission internal combustion engine. In one aspect, operating response of a low emission diesel engine is enhanced and the effectiveness of exhaust emission devices for low emission operation of the diesel engine is maintained. The embodiments are described hereinafter by reference to the accompanying drawings that show the embodiments. These concepts may, however, be embodied in many different forms and should not be construed as limited to the embodiments set forth herein or to any aspect of those embodiments.

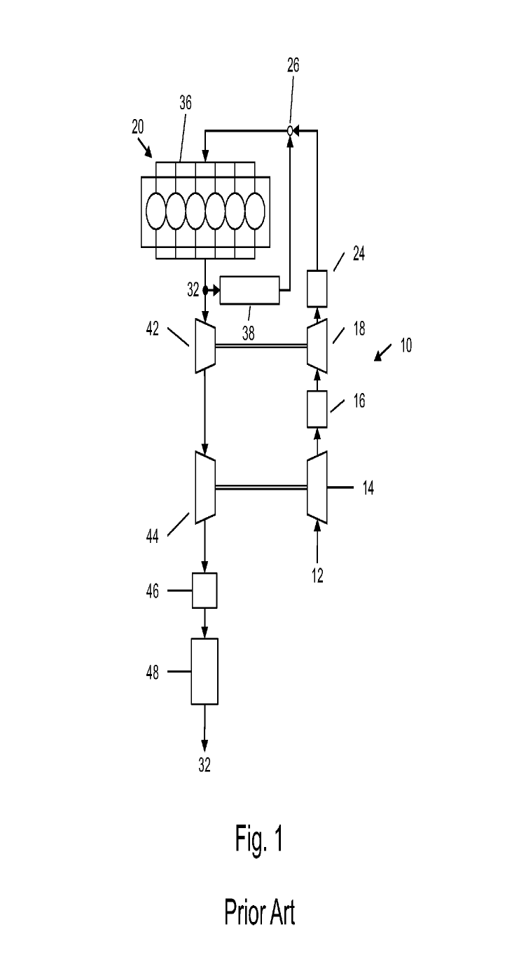

FIG. 1 shows an air intake and exhaust emission system 10 for a diesel engine 20. Air 12 is drawn into the low pressure turbocharger compressor 14 which compresses the air 12 and urges it to and through an intermediate cooler 16 from which the air 12 flows to a high pressure turbocharger compressor 18 that further compresses the air 12 and urges it to a charge air cooler 24. Air 12 passes from the charge air cooler 24 to an exhaust gas recirculation valve 26 by which exhaust gas 32 from the engine 20 is mixed with the air 12. The mixture of air 12 and exhaust gas 32 is directed to the intake manifold 36 of the engine 20.

Exhaust gas 32 leaving the engine 20 and flowing to the exhaust gas recirculation valve 26 is directed to an exhaust gas recirculation (EGR) cooler 38 from which cooled exhaust gas 32 is directed to the exhaust gas recirculation valve 26. Exhaust gas 32 is also directed from the engine 20 to the high pressure turbocharger turbine 42 which drives the high pressure turbocharger compressor 18. Exhaust gas 32 is directed from the high pressure turbocharger turbine 42 to the low pressure turbocharger turbine 44 which drives the low pressure turbocharger compressor 14.

Exhaust gas 32 is then directed from the low pressure turbocharger turbine 44 to a diesel oxidation catalyst 46. The diesel oxidation catalyst 46 catalyzes the oxidation of hydrocarbon and carbon monoxide gaseous pollutants in the exhaust gas 32. Exhaust gas 32 is then directed to a particulate filter 48 that removes particulate matter from the exhaust gas 32. The exhaust gas 32 is then discharged from the system 10.

Diversion of exhaust gas 32 through the EGR cooler 38 decreases the exhaust energy available to drive the high pressure and low pressure turbocharger turbines 42 and 44. During slow operation of the engine 20, this diversion can limit the capacities of the high pressure turbocharger compressor 18 and the low pressure turbocharger compressor 14 to supply air to the engine 20 causing a lack of response to demands for increased energy from the engine 20.

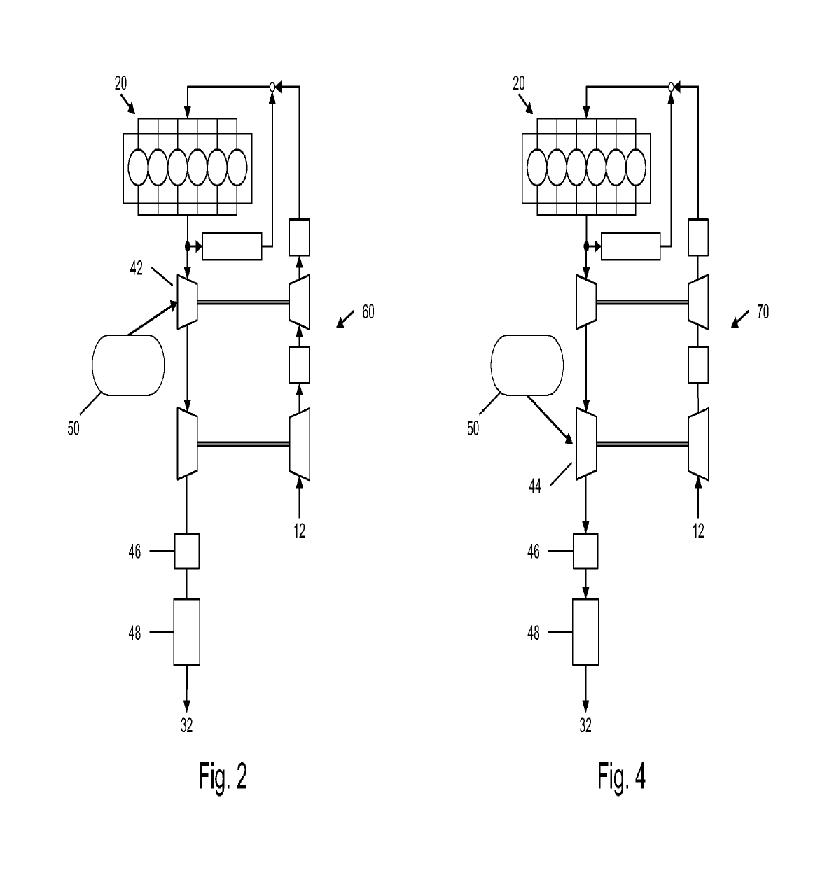

FIG. 2 shows an air intake and exhaust emission system 60 for a diesel engine 20. A source of pressurized air 50 is provided. Air is directed from the source 50 to the high pressure turbocharger turbine 42 to supplement the energy of the exhaust 32 that drives the high pressure turbocharger turbine 42. In addition to increasing the mass and energy of the flow of exhaust gas 32, injecting air into the exhaust as 32 increases the oxygen in the exhaust gas 32 that is available for oxidation and thereby increases the effectiveness of the diesel oxidation catalyst 46 without increasing the engine combustion oxygen content.

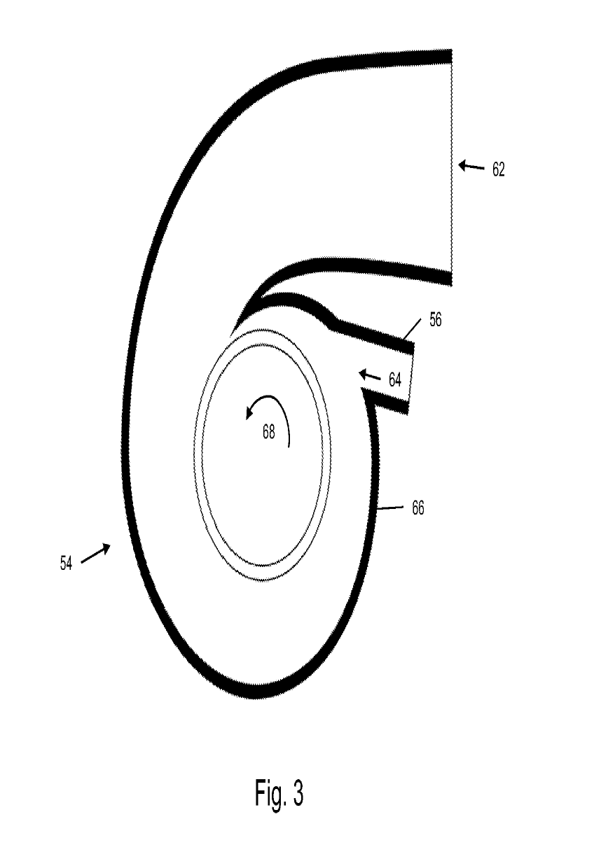

FIG. 3 shows a cross section of a turbocharger turbine housing 54 that includes a turbine flow booster inlet 56. A flow booster inlet 56 is positioned at a location that is separated from the exhaust inlet 62 and at which the wall 66 of the housing 54 is close to the turbine (not shown). The flow booster inlet 56 provides a flow path 64 for air introduced into the housing 54 that is directed tangential to the direction of rotation 68 of the turbine to drive the turbine at a location at which air flow through the inlet 56 impinges almost directly on the turbine and is directed to the outlet of the high pressure turbine 42. Locating the turbine flow booster inlet 56 at this location causes the air that flows through the flow booster inlet 56 to drive the turbine and exit the high pressure turbocharger turbine 42 without causing undesired resistance to the exhaust flow entering the exhaust inlet 62.

FIG. 4 shows another air intake and exhaust emission system 70 for a diesel engine 20. A source of pressurized air 50 is provided. Air is directed from the source 50 to the low pressure turbocharger turbine 44 to supplement the energy of the exhaust gas 32 that drives the turbocharger turbine 44. The low pressure turbocharger turbine 44 has turbocharger turbine housing 54 with a flow booster inlet 56. As described for the system 60, air is injected into the housing 54 to drive the turbine and to increase the oxygen in the exhaust 32 that is available for oxidation and thereby increases the effectiveness of the diesel oxidation catalyst 46.

FIG. 5 shows an embodiment of an air intake and exhaust emission system 70. As shown by FIG. 5, the source of pressurized air 50 may be a supercharger 72.

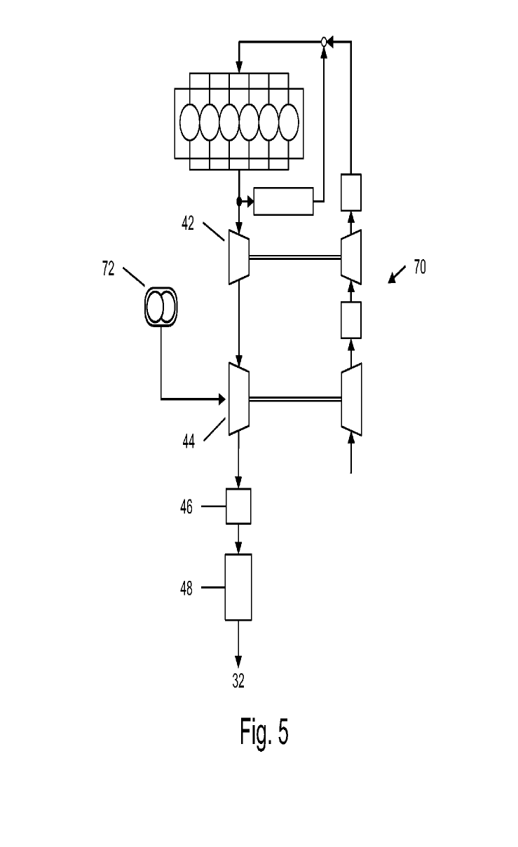

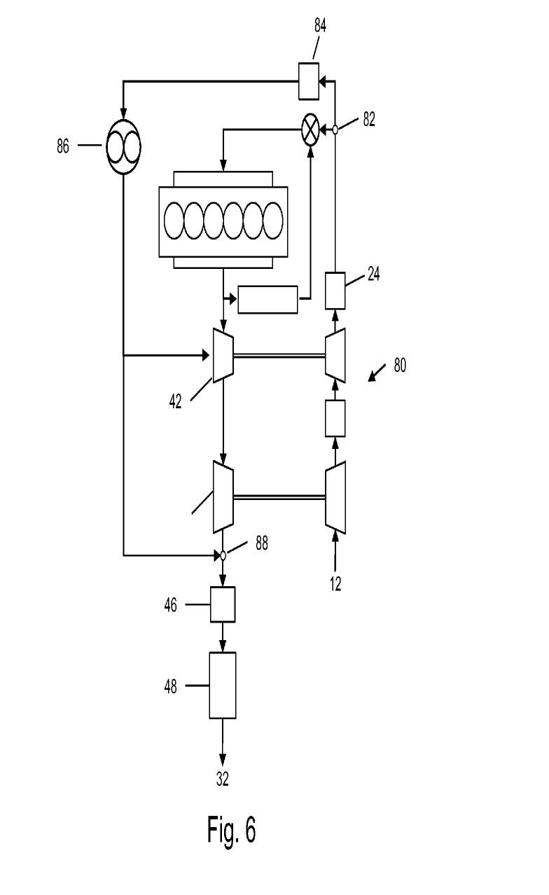

FIG. 6 shows another air intake and exhaust emission system 80 for a diesel engine 20. A compressor intake valve 82 is located between the charge air cooler 24 and the exhaust gas recirculation valve 26. The compressor intake valve 82 diverts air 12 to a compressor pre-cooler 84. Air 12 is directed from the compressor pre-cooler 84 to a compressor 86 that compresses the air 12 and urges the air 12 to high pressure turbocharger turbine 42 as described in the context of air intake and exhaust emission system 60. Air 12 is also directed to a partial burner nozzle 88 that is located in the flow of exhaust gas 32 between the low pressure turbocharger turbine 44 and the diesel oxidation catalyst 46. The partial burner nozzle 86 increases the temperature of the exhaust gas 32 flowing to the diesel oxidation catalyst 46 and the diesel particulate filter 48.

The source of pressurized air 50 may be any apparatus that provides pressurized air such as the supercharger 72 and the compressor 86. The compressor 86 may be any device that functions to compress air as described. The compressor 86 may be driven by one or more apparatus including electrically or mechanically.

The embodiments include a method for increasing the response of a turbocharged engine comprising providing a source of pressurized air and introducing pressurized air from the source of pressurized air into a flow of engine exhaust to a turbocharger turbine in response to a request for increased engine power. The pressurized air may be introduced into the flow of engine exhaust to a turbocharger turbine through a flow booster inlet in a housing of the turbocharger turbine. The source of pressurized air may be a supercharger. Air may be diverted from a flow into an intake of the turbocharged engine to the source of pressurized air and the source of pressurized air pressurizes the air diverted from the flow to the engine intake. Air may be provided air from a source of pressurized air into a flow of exhaust from a turbocharger to an oxidation catalyst. Air may be provided from the source of pressurized air to a partial burner nozzle located in a flow of exhaust from a turbocharger to an oxidation catalyst.

I claim:

1. A method for increasing the response of a turbocharged engine comprising:
providing a source of pressurized air; and
introducing pressurized air from the source of pressurized air into a flow of engine exhaust to a turbocharger turbine in response to a request for increased engine power.

2. The method for increasing the response of a turbocharged engine of claim 1 wherein pressurized air is introduced into the flow of engine exhaust to a turbocharger turbine through a flow booster inlet in a housing of the turbocharger turbine.

3. The method for increasing the response of a turbocharged engine of claim 1 wherein the source of pressurized air is a supercharger.

4. The method for increasing the response of a turbocharged engine of claim 1 wherein air is diverted from a flow into an intake of the turbocharged engine to the source of pressurized air and the source of pressurized air pressurizes the air diverted from the flow to the engine intake.

5. The method for increasing the response of a turbocharged engine of claim 1 further comprising providing air from the source of pressurized air to a flow of exhaust from a turbocharger to an oxidation catalyst.

6. The method for increasing the response of a turbocharged engine of claim 1 further comprising providing air from the source of pressurized air to a partial burner nozzle located in a flow of exhaust from a turbocharger to an oxidation catalyst.
